(19) United States
(12) Patent Application Publication
(10) Pub. No.: US 2017/0236184 A1
(43) Pub. Date: Aug. 17, 2017

(54) METHOD OF MAKING RECOMMENDATION ON PRODUCTS, SERVICES OR CONTENT BASED ON PLANS, ACTIVITIES AND PROFILE IN A PLAN MANAGEMENT APPLICATION

(71) Applicant: PlanCentral, Inc., Hermosa Beach, CA (US)

(72) Inventor: Dale KIM, Redondo Beach, CA (US)

(21) Appl. No.: 15/502,662

(22) PCT Filed: Aug. 11, 2015
(86) PCT No.: PCT/US2015/044742

§ 371 Date: Feb. 8, 2017

Related U.S. Application Data
(60) Provisional application No. 62/042,171, filed on Aug. 26, 2014.
(60) Provisional application No. 62/035,911, filed on Aug. 11, 2014.

(51) Int. Cl. G06Q 30/06; G06Q 10/10

(52) U.S. Cl. CPC G06Q 30/0631; G06Q 30/0625; G06Q 10/103

(57) ABSTRACT

A computer-implemented method of making recommendations on products, services, or content such as instructional information based on information pre-entered by a user is provided. Steps may include recognizing the information of a specific plan or activity, receiving geolocation information of the user or a plan site, conducting an internet search based on the information and the geolocation, sorting and prioritizing search results based on information relating to the plan and the activities and/or profile information, and providing a list of recommendations to the user.

### CROSS-REFERENCE TO RELATED APPLICATIONS

The present application claims the benefits of priority to U.S. Provisional Application No. 62/035,911 filed on Aug. 11, 2014, which is herein incorporated by reference in its entirety.

### FIELD

The present disclosure relates to a method of making recommendations on products, services, or content such as instructional information based on plans, activities, and/or profile information or a plan profile in a plan, activity, or project management application.

### BRIEF DESCRIPTION OF THE DRAWINGS

FIG. 1 is a flowchart diagram of a method of making recommendations on products, services, or content based on plans and activities, according to an embodiment.

FIG. 2 is a representation of a webpage view of a plan page according to an embodiment.

FIG. 3 is an example of a mobile terminal display of a plan page according to an embodiment.

FIG. 4 is a representation of a webpage screen directed at creating a plan.

FIG. 5 is a representation of a webpage screen directed at sharing a plan.

FIG. 6 is a representation of a webpage screen directed at creating an activity.

FIG. 7 is a representation of a webpage screen showing an activities list.

FIG. 8 is an example of match logic used by the method according to an embodiment.

FIG. 9 is a representation of a webpage screen directed at activity based recommendations.

FIG. 10 is a diagram of interconnectivity of users and databases.

FIG. 11 is a high level flow chart describing an embodiment of the invention.

FIG. 12 is a detailed technical flow chart describing an embodiment of the invention.

FIG. 13 is a detailed process flow chart describing an embodiment of the invention.

### DETAILED DESCRIPTION

Planning things such as events, projects, or developments takes coordination, organization, and reliance on useful information. With the global advancement of today's society, companies, teams, and individuals alike are becoming more dependent on technology to stay connected as participants in projects may be located great distances apart. Likewise, the organization of relevant and reliable information has grown increasingly more complicated with the wealth of information located on the internet.

Thus, an application is required which can centralize the requirements of planning events and projects, including forming a team, assigning activities or tasks, performing research, and setting deadlines. Furthermore, an application which may develop and run sophisticated search algorithms using information gleaned from users to provide highly tailored and useful recommendations is required.

The method described herein is distinct from search engine targeted key words for several reasons. First, the core function initiating the suggestion is different. In the application, a user is managing plans and activities. Recommendations on products, services, and content are made in the form of a virtual assistant related to that specific plan or activity. The user's main objective in the application is to complete a plan and its related activities, and the recommendations made are specifically tailored to each activity in the context of its parent plan.

Second, the application must deduce through its own logic what appropriate products, services, or content would assist the user in successfully completing the plan or activity. The application creates its own logic by applying key words from a plan name, an activity name, and an activity description, coupled with location data generated automatically from an application programming interface (API) or input directly by the user to deliver accurate and useful recommendations for completing a plan or activity. Recommendations are provided based on the combination of the plan, activities, and/or profile information in a contextually relevant way so as to assist the user in the most accurate way possible.

The foundation of the application is to allow a user to create a plan and activities that correspond to the plan. This plan can be shared with other team members so that they can view and edit the plan and activities. For example, a plan that a team wishes to accomplish may be called “Build a house.” Team members may then create activities or tasks for the plan, as described below.

### Plan:

Build a house

### Activities:

1. Find location with realtor

2. Obtain permits to build the home

3. Hire architects

4. Approve home blueprints

5. Hire contractors

6. Buy supplies and materials

7. Begin home construction

8. Inspect final construction

9. Furnish and move in

Once activities or tasks are entered for the plan, the application recognizes words or phrases in the plan name to give product, service, or content recommendations relating to the plan and/or activities, or provide additional information. The application will also use the recognized words and phrases from the plan name to put the activities that are added to the plan into context. The application will then match the activities with advertisers, partners, vendors, or affiliates by a targeted web search. Advertisers or vendors who either register with the application or associate with a third party network registered with the application join a partnership network, and thus may be prominently featured in recommendations. Thus, the matches made by the application may be more accurate and tailored to a user's requirements depending on the nature of the plan or activity, the location of the user or planned location of the project or plan, or specific requirements of the plan, activity, user, or team member.

In the example mentioned above, an activity such as activity number 6, “Buy supplies and materials”, may be too broad for the application to associate with a general list of advertisers, partners, vendors, or affiliates within the partnership network. The application would then use the name of the plan, “Build a house”, to narrow down the search to only those advertisers, partners, vendors, or affiliates who are particularly related to the plan; in this case, building a house.

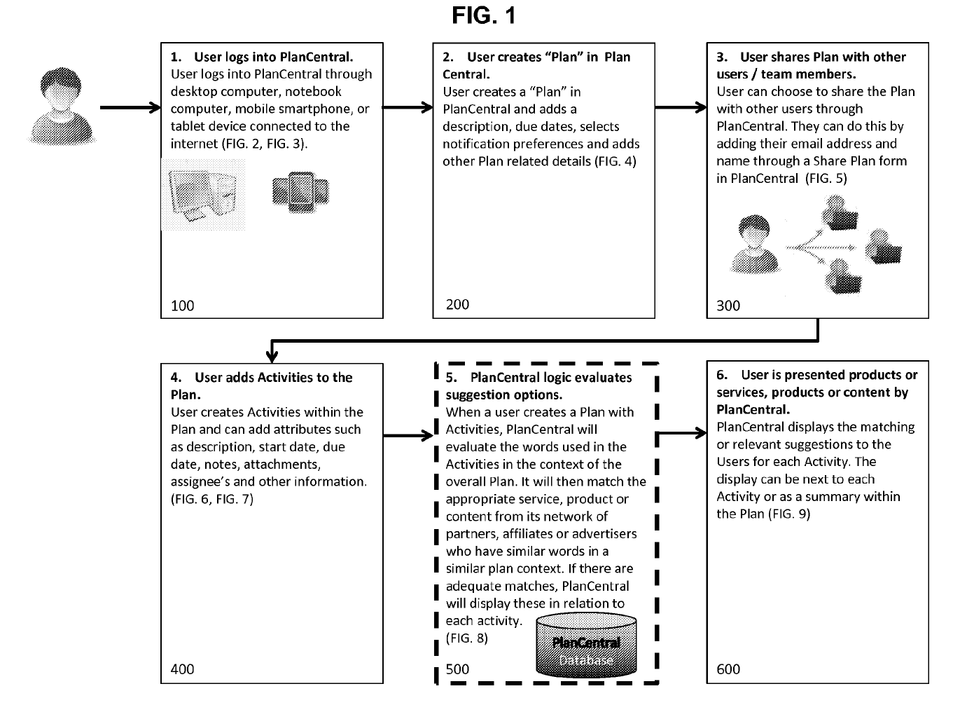

FIG. 1 shows a flowchart of the method in operation according to an embodiment. In the first operation 100, a user logs into the application via a log in email and password. Log in may be done through a web browser on a personal computer, through a mobile smart phone or tablet, or any device connected to the internet, however the method is not limited thereto. The particular user interface may include a keyboard and mouse, voice activation, or a touch screen operation.

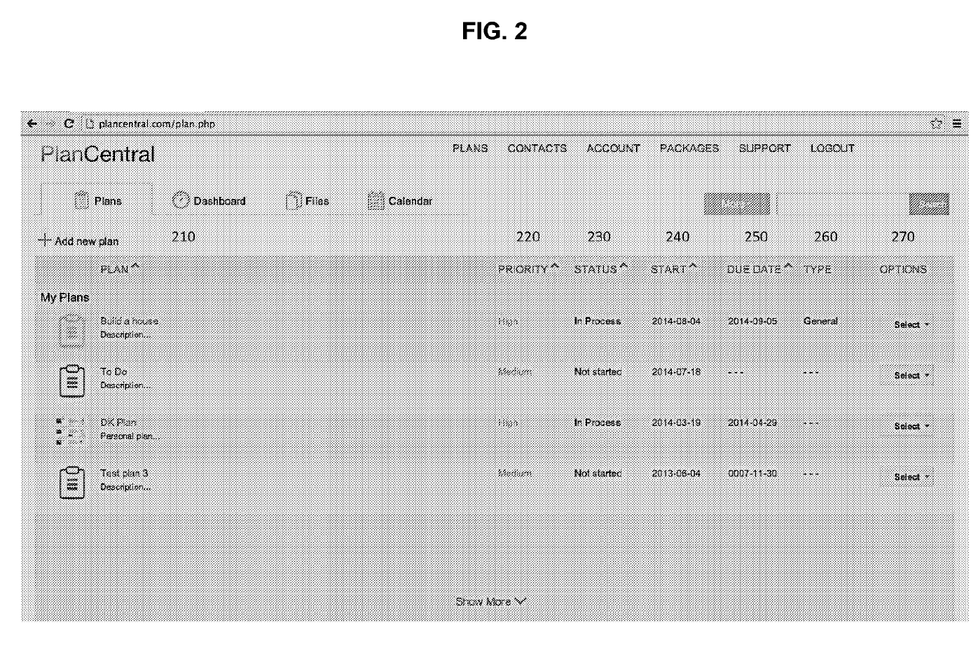

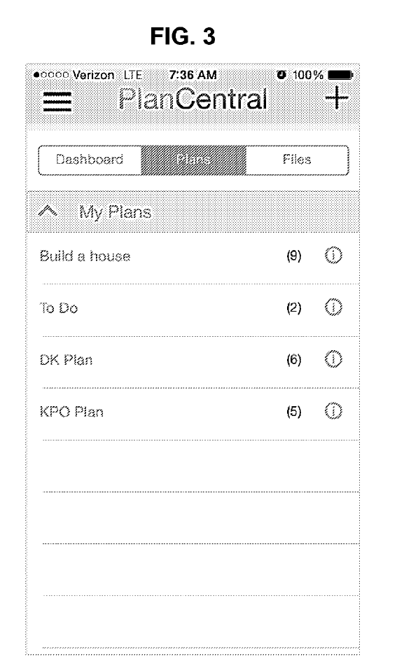

In FIG. 2, a user may access the application on a web browser via a personal computer, a mobile device, or any instrument connected to a network. The first page seen upon logging in is the plans list page, which lists all plans created by the user, plans to which the user has been added, or both. The list of plans may be stored on a master server database accessible by the user and any team members associated with a certain plan, as will be explained further. The list of plans may be sorted by plan name 210, priority 220, which may include high, medium, or low, status 230, which may include not started, in process, hold, or completed, start date 240, or due date 250. Other information may be entered for each plan, such as type 260, which may include general, personal, sales, marketing, design, support, technical, or the like. This information may also be stored on the master server database. FIG. 3 shows an example of a home page of the application on a mobile smart phone, where similar features can be accessed.

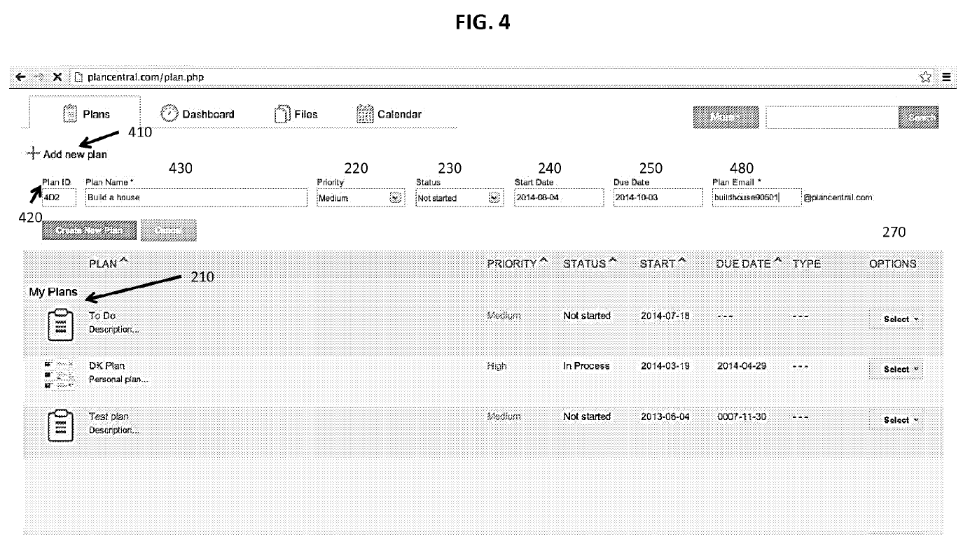

The user then creates a plan by entering information through the personal computer, mobile device, or the like, as described in operation 200 of FIG. 1. As shown in FIG. 4, the user may add a plan by clicking the Add new plan link 410. The user also has an option to form a new plan from a template, in which certain fields are prefilled with select information. When a new plan is added, a Plan ID 420 is automatically generated; however, the user may elect to give the plan a different Plan ID 420. The user may also give the plan a Plan Name 430. More information may be entered relating to the plan, such as the Priority level 220, the Status indication 230, the Start Date 240, the Due Date 250, and a designated Plan Email 480 to which all related correspondence may be sent in order to then be sent out easily to all involved team members associated with the plan. A listing of all plans instituted by the user, or to which the user has been added may be shown. Further details, such as notification preferences and an activities list may be added as well. All information is stored on the master server database, in order to be accessed and edited at any time by any team member via a personal computer, mobile device, or the like, using a network such as the internet, a local area network (LAN), or the like.

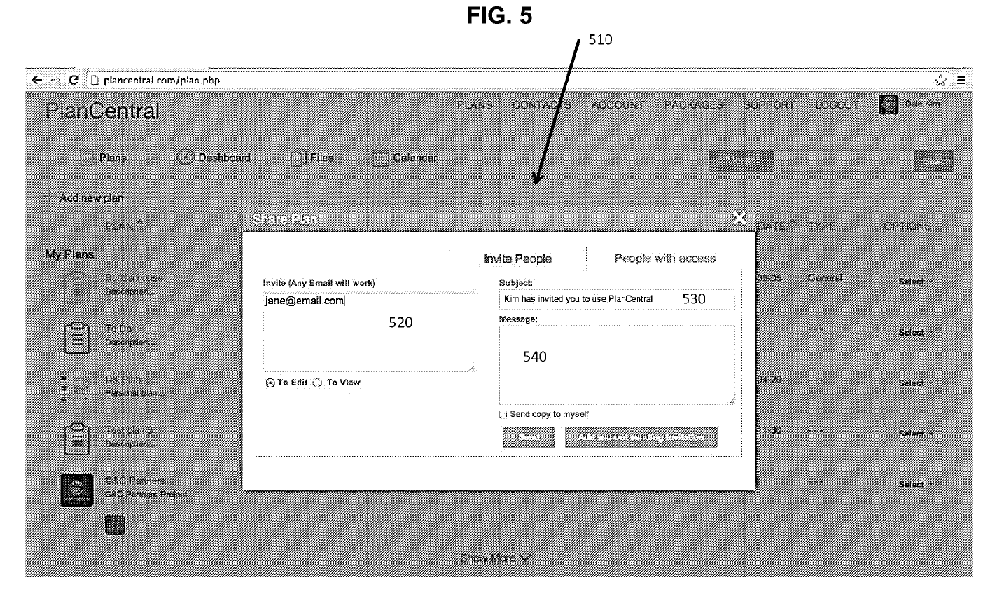

The user may then share the plan with other team members, as described in block 300 of FIG. 1. The user may enter email addresses of other team members that they would like to be associated with the plan, and send out invitations to join the plan. As shown in FIG. 5, the user may open a Share Plan form 510 from the options field 270 and add email addresses of other team members to an invite box 520. The user may then add a subject, such as the plan name or a general invite statement, to the subject box 530. Finally, the user may enter a personal message in the message box 540 to send to the invitees. The user has a further option to send the invite message, or add the requested team member without sending an invitation. Team member information and user profiles may be stored on the master server database.

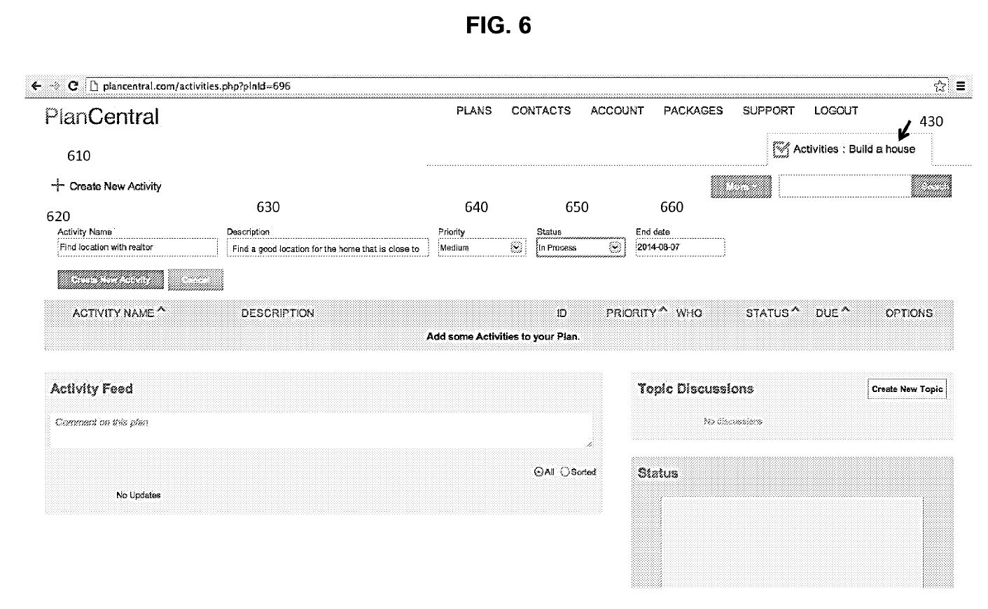

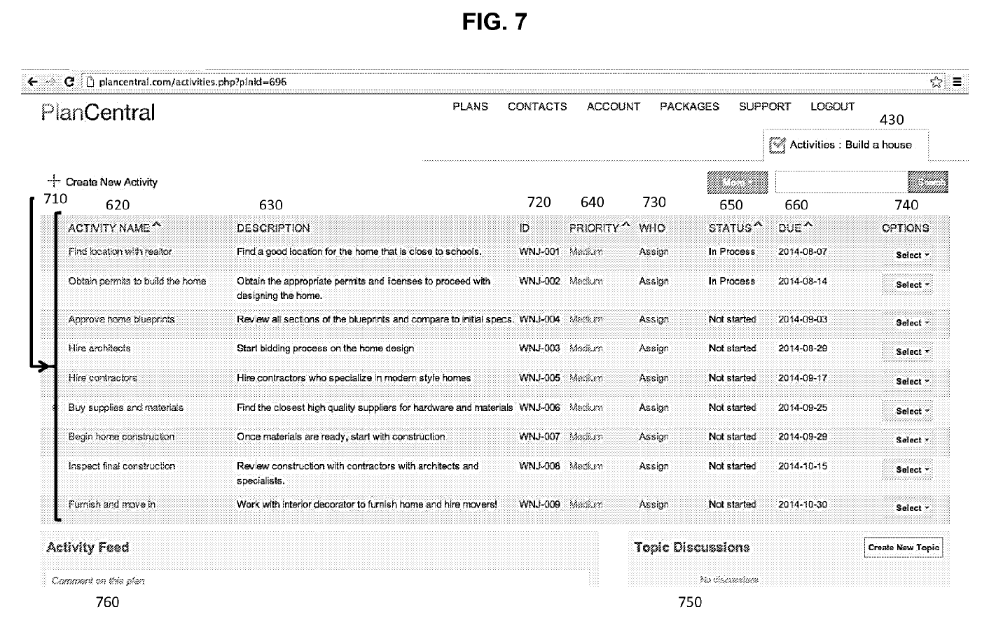

Once the plan is shared with the desired team members, the user or any team member associated with the plan may add activities, as described in block 400 of FIG. 1, and further shown in FIGS. 6 and 7. The user or any team member may enter the activities list page of a certain plan by clicking on the plan name in the list of plans shown on the homepage. The user or team member will be aware of what plan he or she is editing by noticing the plan name 430 in the upper right hand corner of the page. Once on the activities page, the user or team member may click on the “Create New Activity” link 610 to begin describing a new activity. The user or team member may elect to add certain information relating to the activity, such as an Activity Name 620, a Description 630 of the activity, such as step-by-step directions of how to carry out the activity or requirements that are necessary for proper execution of the activity, a Priority 640, which may include high, medium, or low, a Status 650, which may include In Process, Not Started, Done, or Hold, and an End Date 660, by which date the activity should be completed. Plans may be archived by the user upon completion or any time before in order to decrease on screen clutter. Archived plans may still be viewed and edited by the user or a team member.

FIG. 7 shows an example of a list of activities 710 associated with a particular plan. From this page, team members associated with the particular plan may see a summary of all activities associated with the plan. The list of activities 710 may be sorted by such fields as Activity Name 620, Priority 640, Status 650, or Due Date 660; however the disclosure is not limited thereto. When an activity is created by the user or a team member, a particular and unique ID 720 becomes associated with that activity. Additionally, the user or team member may assign one or more team members as responsible for a particular task, by using the Who 730 field. At any time, the user or team member may add or delete a team member from the Who 730 field. An Options 740 field may be added as well, wherein the user or team member may add or associate particular attributes to the activity. Such attributes may include a notification about the particular activity, a time tracker associated with the activity, where the user or team member may track the time spent on the particular activity, a delete option to delete the particular activity, or a recommendations option, which will be described further below. Activity information is stored on the master server database in order to be accessed for editing at any time by any team member via a personal computer, mobile device, or the like through a network.

Additionally, the user or a team member may have an option to add a topic discussion 750. Here, certain notes or topics relating to the plan, a particular activity, or a team member may be generated and listed for viewing by all team members. Each note or topic may start a discussion, to which all team members may contribute with posts. Team members may also upload files such as images, documents, presentations, PDF files, or the like to the activities list page, which may be available for viewing or for download by team members.

Team members may click on individual activities to open a box which shows the details of the activity and allows for editing of the fields mentioned above, such as Activity Name 620, Description 630, Priority 640, Status 650, and End Date 660. The user or team member may also add specific notes related directly to the specific activity in this box. Files, such as images, documents, presentations, PDF files, or the like may also be attached in the notes box, available for viewing or download by team members.

There may be an activity feed 760 on the activities list page, which details any action taken by the user or a team member relating to any of the activities. The user or a team member may also post general comments relating to the activities, which may appear in a list fashion in reverse chronological order.

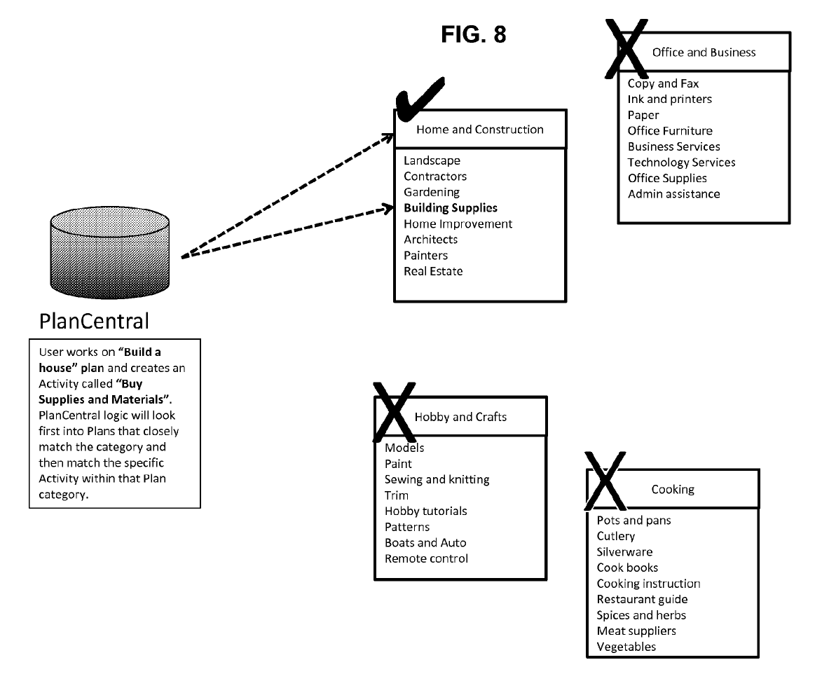

Once activities are created for a specific plan, the application may generate and evaluate recommendation options associated with particular activities, as shown in block 500 of FIG. 1, and FIG. 8. To accomplish this, the application evaluates the words used in the activity name and activity description in the context of the plan name.

For example, the user may create a plan titled “Build a house.” Within this plan, the user may create an activity titled “Buy supplies and materials.” An ordinary search of advertisers, partners, vendors, or affiliates who may be associated with buying supplies and materials may be expansive, and cover a wide range of supplies and materials, many of which would have no association with building a house. The application would then recognize the name of the plan as “Build a house” and restrict its search and recommendation to only those advertisers, partners, vendors, or affiliates who are associated with the construction of a house. Furthermore, the application may check the activity description or other notes entered into the activity to further narrow a search down and generate more targeted recommendations.

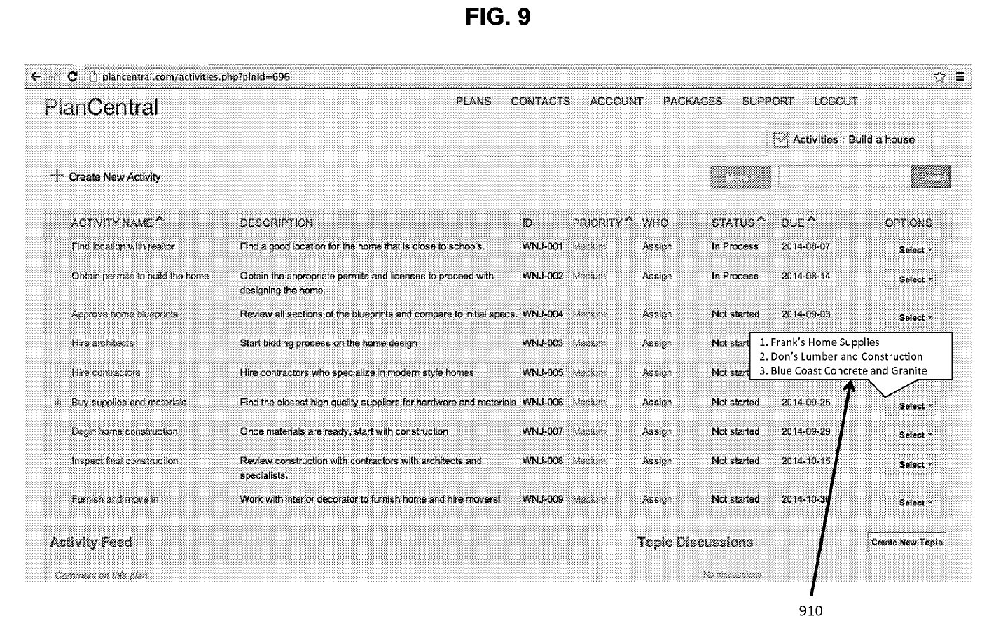

The application uses an API to get specific location information on the user, the plan, or the activity, and incorporates the location information into the search. If the user desires, he or she may override the location information and enter a custom location in which to search. The application then takes information from the plan name, the activity name, and the activity description, coupled with the location information either from the API or the user's entry, and performs a search on an internet search engine, such as Google, Yahoo, Bing, Yelp, or the like. Key words are taken from the plan information, the activity information, and/or the activity description when a search is performed. If adequate matches are found relating to the specific information, the application sorts and prioritizes the recommendations based on the key words in the plan name, the activity name, and the activity description. The application then displays the results for each activity under the recommendations option in a separate pop up block 910, as described in block 600 and seen in FIG. 9. When the results are listed, a hyperlink is provided which may link the user or a team member to a page such as a Yelp review of the selected advertiser, partner, vendor, or affiliate.

Advertisers, vendors, or other interested parties may elect to join a partnership network through the application. By joining the partnership network, a party may be selected as a featured partner when offered as a recommendation for a particular activity. Other benefits may be available to parties who are members of the partnership network. The application may further link with third party networks, thereby incorporating all advertisers, vendors, or other parties associated with the third party network into the partnership network. The application may run initial searches internally through the partnership network to generate featured partners. Furthermore, the partners associated with the partnership network may be ranked by the application according to reviews posted by previous users in order to prioritize certain partners when making recommendations.

The recommendations list generated by the application may be viewed by hovering over an options or setting link associated with the activity. Alternatively, the user may elect to have recommendations automatically pop up for each activity, by adjusting the settings of the plan through a plan profile.

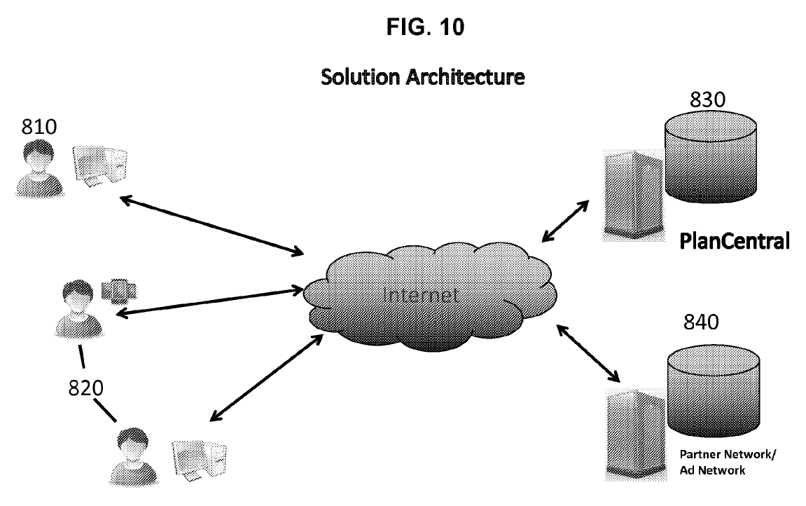

As seen in FIG. 10, the user 810 may be connected to other team members 820 via a network such as the internet. One or more master server databases 830, 840 may be located remotely and accessible by the user 810 and team members 830, 840 at any time and from any location. In this manner, the user 810 or team members 830, 840 may add, edit, or remove information as necessary to tailor plans and projects to needs and requests.

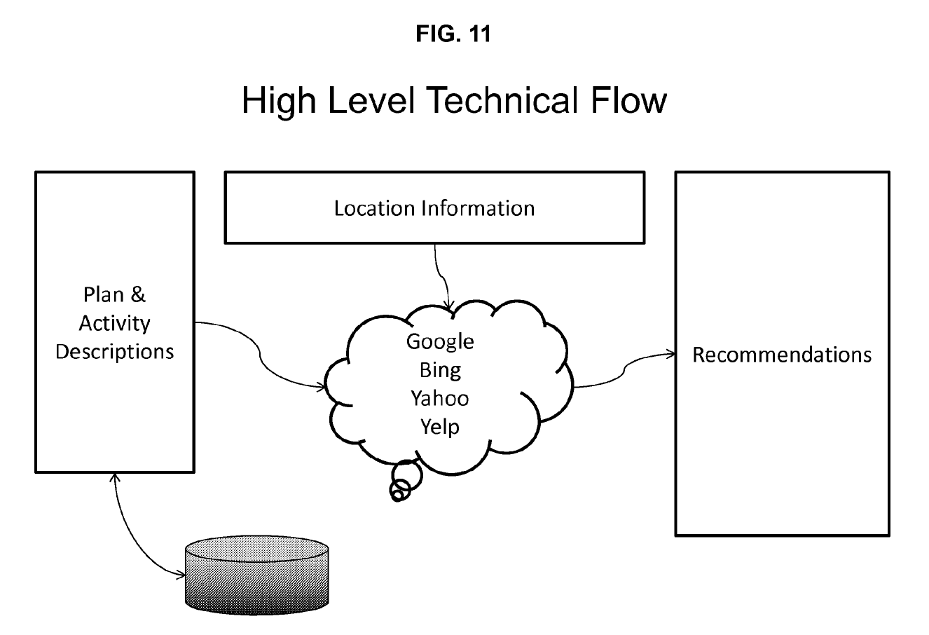

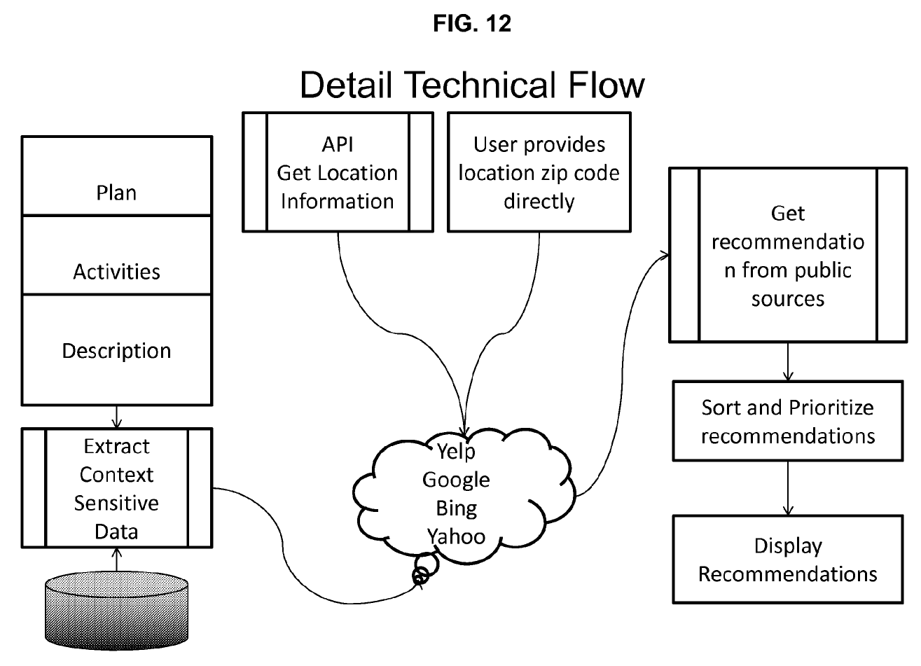

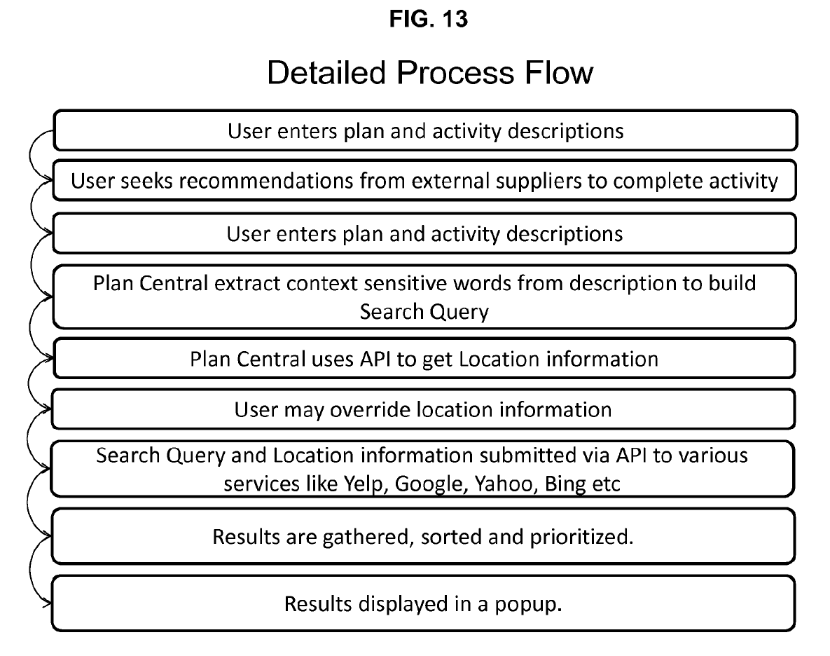

FIG. 11 shows the high level operations of the application, including recognizing the plan and activity descriptions, establishing a location of a project, performing the search, and displaying the recommendations. FIG. 12 provides a more detailed flow of the application. FIG. 13 shows the operation and the operation order of the application.

Embodiments provide an application which is capable of centrally organizing planning of projects and events. Steps may include creating a plan, inviting team members, creating activities, generating recommendations, and displaying recommendations to team members. The application's internal logic applies information from a plan name, an activity name, an activity description, and profile information coupled with location information from an API or a direct input from a user in order to perform a search of advertisers, partners, vendors, or affiliates specifically tailored to the requested plan and activity.

The details of one or more embodiments are set forth in the accompanying drawings and the description. Other features will be apparent from the description and drawings, and from the claims.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A computer-implemented method of making recommendations on products, comprising:
recognizing words or phrases from a plurality of identifiers stored on a memory database;
establishing a location of a user through an application programming interface provided on a display of a network connected device;
applying the words or phrases and the location together in an internet search;
sorting search results according to the words or phrases and location by processing the plurality of identifiers into a list of priorities; and
displaying recommendations based on the sorting of search results on a screen of network connected devices of at least one user.

2. The method of claim 1, wherein the plurality of identifiers includes a plan or project name, an activity name, general comments, and an activity description.

3. The method of claim 1, wherein the location of the user may be established through information entered by the user.

4. A computer-implemented method of making recommendations including a central database, the method comprising:
inputting information relating to a specific user-described plan or protect to the central database by a user, wherein the plan or project includes a plurality of activities;
establishing a location of the user through an application programming interface of a network connected device;
applying the information and the location in a targeted search, wherein the central database uses key words and phrases associated with one of the plurality of activities;
sorting the targeted search results according to a predetermined priority; and
displaying recommendations based on the sorting of search results on a screen of network connected devices of the user, wherein the user further adds an activity feed within the plan or project to allow a plurality of individuals involved in the project to add information, and wherein the central database continuously seams the activity feed to provide updated and more accurate search results and recommendations.

5. The method of claim 4, wherein the information includes an activity name, an activity description, a plan or project name, the location, and key words from the activity feed including general comments.

6. The method of claim 4, wherein information input into the activity feed is automatically uploaded to at least one page of the plan, where the plurality of individuals have access to see content or download files.

7. The method of claim 4, farther including partnership network including featured partners such as advertisers, vendors, and other interested parties, wherein the central database gives preference to members of then partnership network when displaying recommendations.

8. The method of claim 7, wherein the central database first searches the partnership network to display the featured partners according to rankings, and secondarily searches the internet to produce further results.

9. The method of claim 4, wherein any one of the plurality of individuals is allowed access to the central database at any time through a network connected device to update or add information, and wherein the central database automatically updates a search relevant to the updated or added information to provide updated results.

10. A search and recommendation application, comprising:
a master server database containing information input by a plurality of individuals involved in a protect or plan; and
a plurality of network devices connected to a network and configured to allow the plurality of users to access from and input information to the master server database, wherein the master server database is configured to compile multiple data points and produce narrowly tailored search results by continually updating search criteria with information input by the plurality of individuals, and wherein the master server database first searches an internal database of pre-stored vendors and advertisers to deliver recommendations before further performing an internet search.

11. The application of claim 10, wherein the master server database is configured to establish a location of one of the plurality of users to produce search results tailored specifically to the location.

12. The application of claim 10, wherein the information input by the plurality of individuals are classified into plan name, plan description, activity name, activity description, special request notes, and general comments relating to activities.

13. The application of claim 12, wherein the information further includes specific notes directly related to specific activities input by the plurality of individuals, and wherein the specific notes are automatically added to one of the classifications.

14. The application of claim 10, wherein the plurality of network devices includes mobile terminals, laptops, personal, computers, car tablets, and wherein the master server database displays the search results on the plurality of network devices to be viewed by any one of the plurality of users.

15. The application of claim 10, wherein the master server database provides search results of pre-stored vendors based on positive reviews given to vendors by previous users or previous projects or plans.
